(19) United States
(12) Patent Application Publication
(10) Pub. No.: US 2023/0281463 A1
(43) Pub. Date: Sep. 7, 2023

(54) RUNTIME-SPECIFIC PARTITIONING OF MACHINE LEARNING MODELS

(71) Applicant: Adobe Inc., San Jose, CA (US)

(72) Inventors: Priyanka Kulkarni, Santa Clara, CA (US); Laurie Byrum, Pleasanton, CA (US); Curtis Wigington, San Jose, CA (US); Matthew Crosby, Vashon, WA (US); Pallav Vyas, San Jose, CA (US)

(21) Appl. No.: 17/684,680

(22) Filed: Mar. 2, 2022

(51) Int. Cl. G06N 3/10; G06N 3/04

(52) U.S. Cl. CPC G06N 3/10; G06N 3/0454

(57) ABSTRACT

Certain aspects and features of this disclosure relate to partitioning machine learning models. For example, a method includes accessing a machine learning model configured for processing a data object and partitioning the machine learning model into a number of partitions. Each of the partitions of the machine learning model is characterized with respect to runtime requirements. Each of the partitions of the machine learning model is executed using a runtime environment corresponding to runtime requirements of the respective partition to process the data object. Output can be rendered based on the processing of the data object.

### TECHNICAL FIELD

The present disclosure generally relates to using machine learning models for processing data objects such as documents, images, or multimedia presentations. More specifically, but not by way of limitation, the present disclosure relates to programmatic techniques for characterizing and partitioning such a machine learning model for more efficient processing.

### BACKGROUND

Common computing devices, including smartphones, tablets, and notebook computers, are becoming more and more capable and thus machine learning models are increasingly designed for such devices. For example, the processing of a document by such a device for rendering may be streamlined using a neural network-based machine learning model when the pages are rendered in order. The device renders early pages of the document quickly, and then continues to process the subsequent pages for efficient rendering using machine learning as the pages are being rendered. Machine learning models can also be used to adaptively predict user input to enhance actual or perceived performance of games or other applications.

### SUMMARY

Certain aspects and features of the present disclosure relate to a computer-implemented method. The method includes accessing a machine learning model configured for processing a data object and partitioning the machine learning model into a number of partitions. The method further includes characterizing each of the partitions of the machine learning model with respect to runtime requirements. The method also includes executing each of the partitions of the machine learning model using a runtime environment corresponding to runtime requirements of the respective partition to process the data object, and rendering output based on the processing of the data object.

Other embodiments of this aspect include corresponding computer systems, apparatus, and computer programs recorded on one or more computer storage devices, each configured to perform the actions of the methods.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram showing an example of a computing environment for runtime-specific partitioning of machine learning models according to certain embodiments.

FIG. 2 is an example of a computing device on which runtime-specific partitioning of a machine learning model is being used according to certain embodiments.

FIG. 3 is a flowchart of an example of a process for runtime-specific partitioning of machine learning models according to certain embodiments.

FIG. 4 is a block diagram depicting a machine learning model being partitioned according to certain embodiments.

FIG. 5 is a block diagram of a partitioned machine learning model according to certain embodiments.

FIG. 6 is a flowchart of another example of a process for runtime-specific partitioning of machine learning models according to certain embodiments.

FIG. 7 is a diagram of an example of a computing system that can implement runtime-specific partitioning of machine learning models according to certain embodiments.

### DETAILED DESCRIPTION

As described above, machine learning models can be used on smartphones, tablets, and other computing devices to improve the user experience. However, existing methods of executing machine learning models on end-user computing devices can strain the computing resources of such devices. However, techniques to process portions of an object such as a stored document and/or image using a machine learning model while other portions of the object are being rendered or otherwise output can result in resource competition between operating system or application components, which can in turn result in undesirable effects, such as staggered or delayed scrolling and visual artifacts.. For example, when rendering documents on a low-end device, jank may be observed. Jank is a term for stuttering in scrolling or other user interface activity caused by skipped frames. Jank can result from a machine learning model’s extended use of GPU resources.

Machine learning models can be selected and executed to minimize such undesirable effects. For example, a neural architecture search (NAS) can be executed by a software development platform or otherwise employed to find the best neural network for a given task and device, one that balances accuracy, processing time, memory usage, etc. Once the appropriate neural network is selected using NAS, the application that runs the network can be designed to use the most appropriate computing resources for that network architecture. NAS design approaches find neural networks that are suited for a particular task, but they treat the network as a unitary framework to be used for the task even though different layers of the network may require different resources for their most efficient execution. Thus, finding the most efficient model for a given application in order to minimize these issues often does not completely eliminate the problem.

Selecting the best machine learning model to minimize undesirable effects can be burdensome for developers. Manual searches are time consuming, and must be repeated at regular intervals as new versions of the software are developed since the array of machine learning models available is continuously changing. NAS approaches to development can also be expensive as they can require many high-end GPUs to perform an effective search.

Embodiments described herein address these issues by programmatically dividing or partitioning a machine learning model to run different parts of the model with different runtime profiles to balance trade-offs between execution speed and undesirable effects in output. When, or before a computing device accesses an object and a machine learning model configured for processing the object, the model is divided into multiple partitions. For example, if the machine learning model is a neural network, each partition includes a subset of layers of the entire network. A computing device characterizes each of the partitions of the machine learning model with respect to runtime requirements and executes each of the partitions using a runtime environment corresponding to the respective runtime requirements of each partition in order to process the object. Output can then be rendered based on this processing, which is more efficient than processing the object while treating the model as a unitary framework to be processed entirely with one set of runtime requirements. Since this partitioning greatly improves the performance of any model, developers can choose from a variety of models without conducting an exhaustive search to find the one model that would provide the best overall performance. Developers thus have more flexibility to choose from various machine learning models to accomplish a task, streamlining the development process for applications or new versions of applications.

For example, a document viewing application provides a computing device with the capability of displaying and scrolling through a document with various types of information such as graphics, text, tables, photos, or even embedded videos. An on-device neural network used for processing such a document uses different layers to process the various types of information in the document. Some layers may execute more efficiently in one runtime environment while other layers may execute more efficiently in another. For example, some layers may have more GPU-efficient runtime requirements and other may have more CPU-efficient runtime requirements. As another example, some layers may run more efficiently in a runtime environment that relies on low-memory, complex operators, others may run more efficiently in an environment that makes use of high-memory optimized resources, while others may run most efficiently using specialized post-processing. Rather than running the entire model in a single environment, and in order to take advantage of these varying requirements for layers of the neural network, the model is partitioned to run different parts of the model with different runtime profiles. A computing device characterizes each of the partitions of the model with respect to runtime requirements and executes each of the partitions in real time using a runtime environment corresponding to the respective runtime requirements. Scrolling and other movement between different parts of the displayed document is smooth, with little or no dropped frames or stuttering. Partitioning of the model can be accomplished on the end-user device, either statically as part of the installation or startup of an application, or dynamically depending on settings or other conditions. Alternatively, partitioning of the model can be accomplished during application development and/or deployment, with the partitioned model being distributed for installation along with or as part of the application.

In some examples, partitioning of the machine learning model can also be used to provide more targeted information security, which can further improve performance. For example, instead of encrypting the entire model, the system can make use of a model with encryption applied only to partitions that include or process sensitive information. In some examples, some partitions can be stored off-device, on a server or in the cloud, to further improve resource utilization or reduce on-device storage requirements. Partitions can also be reused for multiple applications. Developers can select any of various models and achieve a high level of performance without necessarily selecting one model that is a compromise for some functions while being the best for other functions.

The use of partitioned machine learning models for processing objects can provide seamless object processing without slowdowns or interruptions, especially for real-time applications that are increasingly used on mobile computing devices. Splitting the model into smaller partitions provides for more efficient memory use. Certain blocks of operators use less memory when run on CPU, a GPU, or other delegates of the operating system and optimizing the use of these resources translates into better performance and stability, as compared to picking a single delegate to run the entire model. The model-partitioning approach disclosed herein can be used for many types of processing of various data objects types. Operations for handling presentation media such as document display, image display, audio processing, automated translation, and automated captioning are but a few examples.

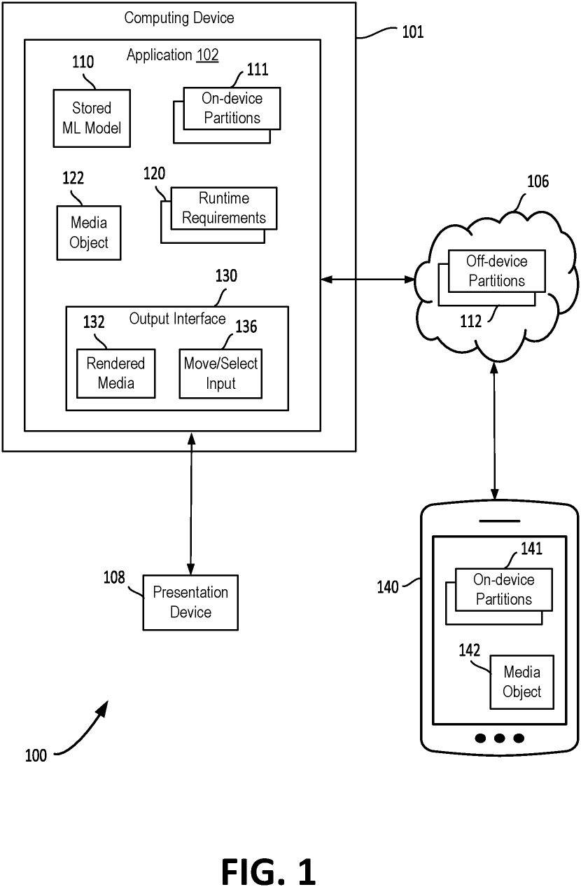

FIG. 1 is a diagram showing an example of a computing environment 100 for runtime-specific partitioning, according to certain embodiments. The computing environment 100 includes computing device 101 that executes an application 102, and a presentation device 108 that is controlled based on the application 102. A cloud computing system 106 in this example is connected to computing device 101. Optionally, off-device model partitions 112 can be accessed by computing device 101 and used by application 102 to render media or perform other tasks. In some examples, application 102 is a document storage and viewing application. In such an example, the application 102 includes the stored, original machine learning model 110. This stored, original model is partitioned to form on-device partitions 111 and optionally off-device partitions 112. Machine learning model 110 may be deleted once the model’s partitions are created and stored, for example, during installation or updating of the application 102.

The application 102 also generates an output interface 130. Output interface 130 is used by application 102 to produce rendered media 132 from stored media object 122. For example, stored media object 122 may be a document and rendered media 132 may include various pages with graphics, photos, text, etc. In some embodiments, the application 102 uses, movement and selection inputs 136, which can include touch, pointing device signals and the like, for scrolling, movement, or selection and overall control of rendered media 132. These interactions with rendered media 132 are made more smooth and efficient through applying the most efficient runtime environments in accordance with runtime requirement definitions 120 to each of the partitions 111 of the machine learning model 110. While some examples are presented as that of a document viewing application rendering a document, an application using runtime-specific partitioning can be used for any type of data object, or for processing other rendering. Examples include editing, viewing, or analyzing documents, images, video, or audio, text or speech translation, graphic production, media streaming, and automated captioning.

In another example, partitioning may be accomplished when the application is compiled or distributed, in which case, application 102 is a software development platform or software distribution application. In this case, the application with the partitioned model is forwarded to and resides on end-user computing device 140 (a tablet computer) and may be deployed to device 140 through cloud computing system 106. In this case, on-device partitions 141 are used in processing media object 142. An output interface may not be fully implemented by application 102, but instead may be provided by computing device 140, with movement and selection inputs provided through a touchscreen.

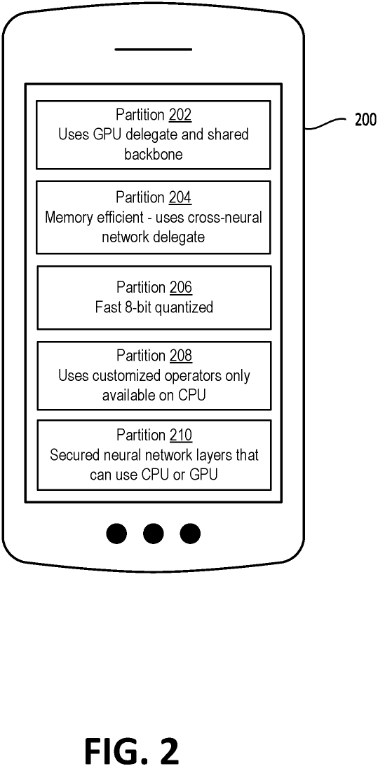

FIG. 2 is an example of a computing device 200 on which runtime-specific partitioning of a machine learning model is being used. An application (not shown) running on computing device 200 is making use of a deep learning neural network model that has been partitioned. Other types of machine learning models can be used. The partitions have been characterized with respect to runtime requirements and each partition is being executed using a runtime environment corresponding to the runtime requirements. By dividing the model into split runtime profiles, trade-offs between undesirable user interface problems and the execution speed of the model can be balanced.

Partition 202 in FIG. 2 uses a GPU delegate and a shared neural network backbone as that is the runtime environment most consistent with its runtime characteristics. Partition 204 is highly memory efficient. Partition 204 uses a cross-neural network delegate. A delegate is an accelerator provided by the operation system. Delegates have different configurations that can used to run machine learning models on a device such as computing device 200. Each has different implementations to accelerate different types of operations so that the operations can be accomplished as efficiently as possible. Examples include a GPU delegate, a digital signal processing delegate, and cross-neural network (XNN) delegates. Other examples include delegates for 32-bit, 16-bit, and 8-bit processing that can be used to fine tune performance by providing a lower level of precision than higher precision values are not required.

Still referring to FIG. 2, partition 206 is used to perform operations that require relatively little precision. Thus, partition 206 runs most efficiently using a delegate for fast, 8-bit quantized processing. Partition 208 runs most efficiently using customized operators that are only available on the CPU of computing device 200 and thus runs on the CPU using a CPU delegate. Partition 210 includes neural network layers that require enhanced security. While this partition and the functions of the application making use of this partition can run on either the CPU, or the GPU, the application applies encryption to the neural network layers running in partition 210 in order to maintain and enhanced level of security for these layers.

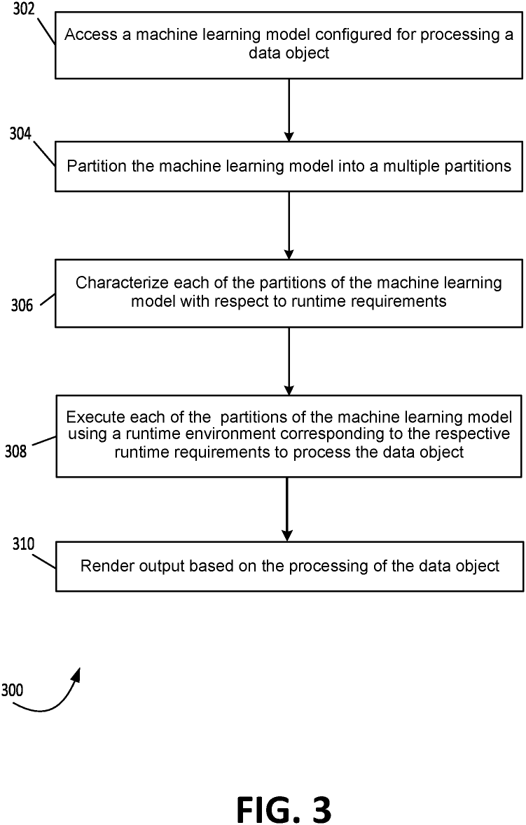

FIG. 3 is a flowchart of an example of a process 300 for runtime-specific partitioning of machine learning models according to certain embodiments. In this example, a computing device such as computing device 101 or computing device 200 carries out the process by executing suitable program code, for example, computer program code for an application such as application 102. At block 302, the computing device accesses a machine learning model configured for processing a data object. At block 304, the computing device partitions the machine learning model into multiple partitions. At block 306, the computing device characterizes each of the partitions of the machine learning model with respect to runtime requirements for running each particular partition of the model most efficiently. For example, computing device 200 includes partition 206 that runs most advantageously with 8-bit processing and also includes partition 208 that requires operators only available on the CPU.

At block 308 of process 300, the computing device executes each of the partitions of the machine learning model using a runtime environment that corresponds to the respective runtime requirements in order to process the data object. To continue with the example of computing device 200, partition 206 is run with fast, 8-bit, quantized processing and partition 208 is restricted to the CPU as opposed to the GPU of computing device 200. At block 310, the computing device renders output based on the processing of the data object. This output may be, as examples, a portion of a document, where the document is the data object being processed, or a portion of a video if a video file is the data object being processed.

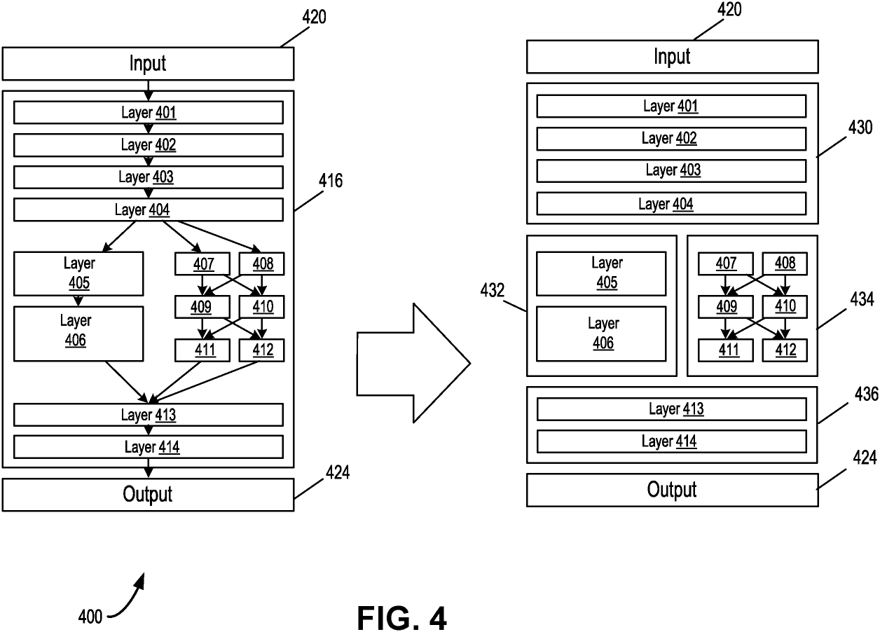

FIG. 4 is a block diagram depicting the partitioning 400 of a machine learning model according to certain embodiments. The neural network model as illustrated in FIG. 4 includes layers 401-404, forming a highly optimized shared backbone that has been pre-trained. In one example, these layers can be copied from an existing model. Layer 405 and layer 406 are high-memory layers. However, layers 405 and 406 use very straightforward and highly optimized operators such as a 3 x 3, two-dimensional (2D) convolutional operator. Layers 405 and 406 can be efficiently computed on the GPU of a computing device.

Continuing with FIG. 4, layers 407-412 use low memory, but use complex operators. Such layers are most efficiently run on the CPU, thus, maximum efficiency may be attained by limiting the execution of such layers to the CPU only. As one example, such layers may be recurrent layers that, while not using much memory, are not easy to parallelize. Layers 413 and 414 are specialized post processing layers such as those used for non-maximum suppression, which may not be possible to execute with off-the-shelf runtime libraries.

All of the above-mentioned layers can be included in on-device neural network model 416, shown on the left side of FIG. 4, which accepts input 420 and produces output 424. In such a case, a single runtime environment would be used to execute model 416 and the runtime environment would be selected to maintain the best performance overall. However, in this example, model 416 is partitioned during development, deployment, installation, or start-up of the application that incorporates or uses the model, as shown on the right side of FIG. 4. Partition 430 is used to execute the shared backbone formed by layers 401-404. This shared backbone is highly optimized for 8-bit processing and can run in a GPU, CPU or tensor processing unit (TPU). These layers may be copied from a publicly available model, so that no encryption or security is required. Partition 432 includes layers 405 and 406. These layers may consume high memory and are best executed using 16-bit precision. Additionally, these layers include straightforward operations, such as a 3 x 3 2D convolution. Partition 432 can most efficiently be executed by a GPU. Partition 434 in FIG. 4 is for layers 407-412, which exhibit low memory consumption but need high precision (32-bit floating point) calculations. These layers also include operations that are not supported by the GPU and thus require the CPU

Partition 436 is for layers 413 and 414, which are custom, non-maximum suppression layers that run outside the typical machine learning runtime environment. Layers 413 and 414 are used for post processing. An application using a model as described above has been tested both with partitioning and without partitioning. The partitioning resulted in a 30 % savings in memory consumption, primarily due to partitions other than the backbone partition 430 consuming far less memory running using an XNN neural network package or using the CPU By splitting up the original model 416, greater control is provided to determine which partitions can be sped up in different ways to achieve the lowest inference time. For instance, certain blocks of operators run fastest on the CPU, whereas other, highly parallelizable partitions run faster on the GPU. Further, partitions can be quantized selectively to 16-bit or 8-bit processes to provide the least expense of accuracy but improve the time taken to obtain the model’s result.

As previously mentioned, with document viewing applications, on-device deep learning models may compete for resources with other models as well as the UI rendering processing on the GPU causing jank, which can be especially noticeable when input such as pinching, scrolling, and zooming is received. Partitioning so that the model does not hold onto the GPU for the entire duration of the model inference can significantly reduce jank. Further, by processing partitions that can run more efficiently on the CPU using the CPU, or by using an XNN package delegate, instead of the GPU, processor cycles needed for the UI thread to render smoothly can run in parallel with the model inference.

As an example, a document viewing application has been run both with and without partitioning of the model used by the application. Without partitioning, the application used the GPU for processing. The partitioning resulted in the offloading of some partitions to an XNN package delegate or the CPU while running the only remaining partitions on the GPU. The latency of the offloaded partitions was reduced, in at least one instance by almost 700 ms, which noticeably reduced jank.

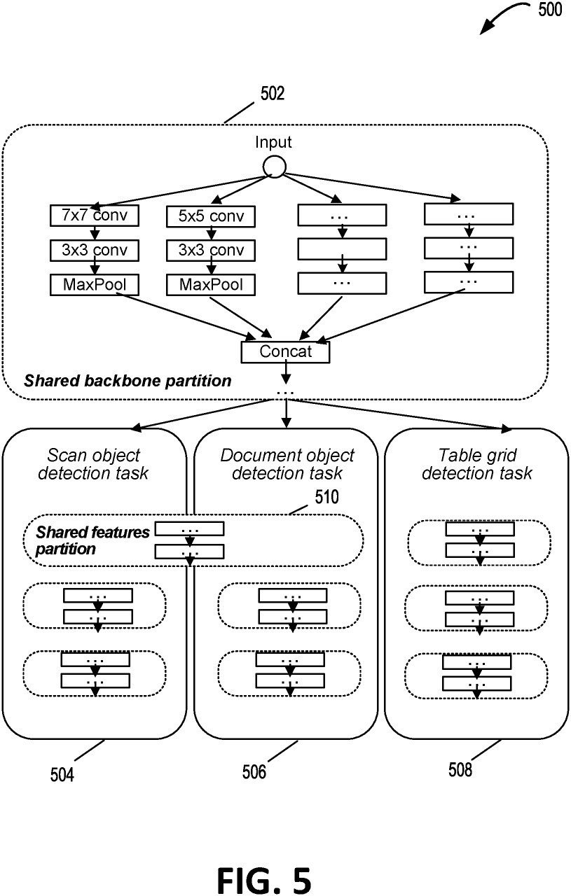

FIG. 5 is a block diagram of a partitioned machine learning model 500 according to certain embodiments. As already discussed, some partitions can be reused for different models and/or applications. Model 500 includes shared partitions and these partitions’ relative processing weights can be varied across different models - reducing computation time, memory usage, and resource contention among multiple models deployed to the same computing device. Model 500 includes a shared, common backbone partition 502, which can be used by different neural networks trained for different tasks, or to augment an already-trained model for detection of additional classes. Backbone partition 502 includes layers for N x N convolution, concatenation, and maximum value (max pooling) convolution. These operations are optimized to run on a GPU. The output of backbone 502 is used by three neural network partitions, partition 504 to implement a scan object detection task, partition 506 to implement a document object detection task, and partition 508 to implement a table grid detection task. Each of these network partitions can in turn be further partitioned to run optimally on GPU, CPU, XNN package, etc.

The use of shared partitions is not limited to backbones. Partition 504 and partition 510 both include portions of additional shared partition 510. Such a system of partitions provides flexibility and control over the orchestration of running multiple models in parallel to stay within performance targets.

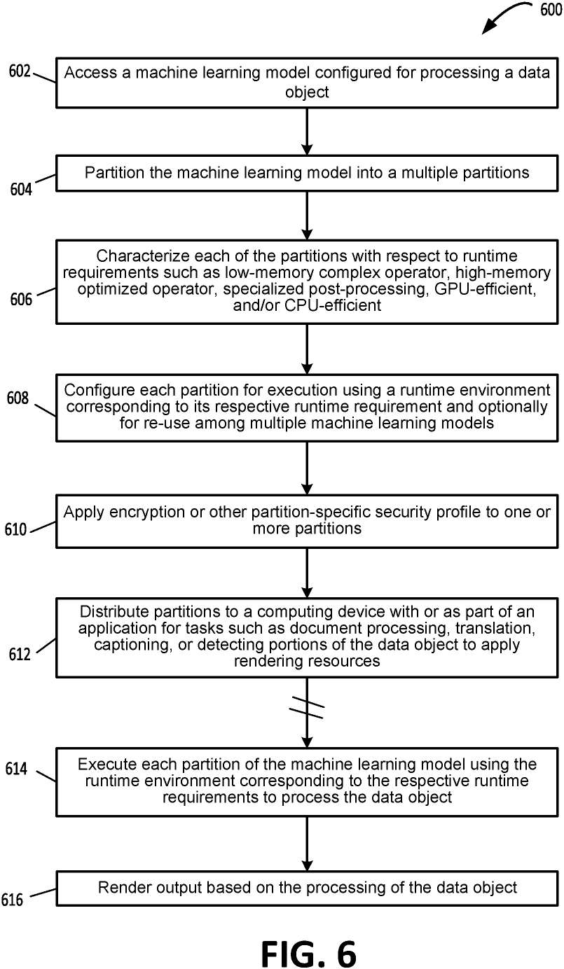

FIG. 6 is a flowchart of another example of a process 600 for runtime-specific partitioning of machine learning models according to certain embodiments. In this example, a computing device carries out the a first portion of the process by executing suitable program code, for example, computer program code for an application such as application 102. For purposes of this example, partitioning of the model is accomplished during application deployment by computing device 101, with the partitioned model being distributed for installation along with or as part of the application. On-device partitions 141 and/or off-device partitions 112 are then used by computer program code or instructions (not shown) in computing device 140 to process media object 142.

At block 602 of process 600, the computing device 101 accesses stored machine learning model 110 configured for processing a data object. At block 604, computing device 101 partitions the machine learning model into multiple partitions 111 and/or 112. At block 606, computing device 101 characterizes each of the partitions of the machine learning model with respect to runtime requirement definitions 120 for running each particular partition of the model most efficiently on computing device 140. For example, a partition may run most efficiently with resources designed for a low memory, complex operator, or a high memory, optimized operator. A partition may run most efficiently using specialized post processing. As other examples, some partitions may be more GPU efficient while other partitions may be more CPU efficient, while still other partitions can run efficiently in either the GPU or the CPU In some examples, the partitioning of the model provides for a more compact memory footprint, in part by bypassing and improving on the default configurations imposed by the end-user computing device or its operating system frameworks. The functions included in block 602, block 604, block 606, and block 608, all discussed with respect to FIG. 6, can be used in implementing a step for providing partitions of the machine learning model configured for processing a data object, wherein each partition is configured for execution using a runtime environment corresponding to its respective runtime requirements. At block 610, a partition specific security profile can be optionally applied to one or more partitions. For example, encryption can be applied to one or more partitions of the machine learning model. Alternatively, partitions can be offloaded into the cloud for security purposes in addition to or instead of for reducing on-device storage requirements. In this case, the cloud system includes high security access features such as end-to-end encryption of the communication path, multifactor authentication, and/or cloud-based encryption.

Continuing with FIG. 6, at block 612, in this example, the partitions are distributed by computing device 101 to computing device 140 with, or as part of, an application for tasks such as document processing, translation, captioning, or detecting portions of the data object in order to more efficiently apply rendering resources. As another example, specialized captions or alternate fonts can be created for a document or other media and displayed for a visually-impaired person without significant performance impacts. Each partition is distributed and ultimately saved to storage on computing device 140 in its own file. At block 614, computing device 140 executes each of the partitions of the machine learning model using a runtime environment that corresponds to the respective runtime requirements in order to process media object 142. At block 616, computing device 140 renders output based on the processing of the data object.

While the examples above make use of deep learning neural networks, other types of machine learning models can be partitioned as described herein. For example, a random forest model can be used. Such models are typically very wide instead of very deep. It can be beneficial to break down such a model based on input features; this would allow for control of the memory needed by a very wide model vs. the potential for significant parallelism. The same security considerations previously mentioned with respect to deep learning neural networks also exist with deep forest models, i.e. that only part of the model needs to be encrypted.

A software development or distribution platform that partitions a model and includes the partitions in software that is destined for various end-user devices can create customized partitioning based on each device or type of device. For example, low-end mobile devices often have limited memory or computational power compared to mid or high-end devices. With unitary machine learning models, owing to strict resource constraints, such devices are often not eligible for deployment of machine learning models due to performance issues when run in the usual configuration. Partitioning as described herein makes it possible to have fine-grained control of the manner of dividing the machine learning model to prioritize lower resource use, energy efficiency and other characteristics to enable deployed software to meet performance goals on low-end devices. A single machine learning model can be split into different partitions in different ways on a per-device or per tier basis to achieve the best results.

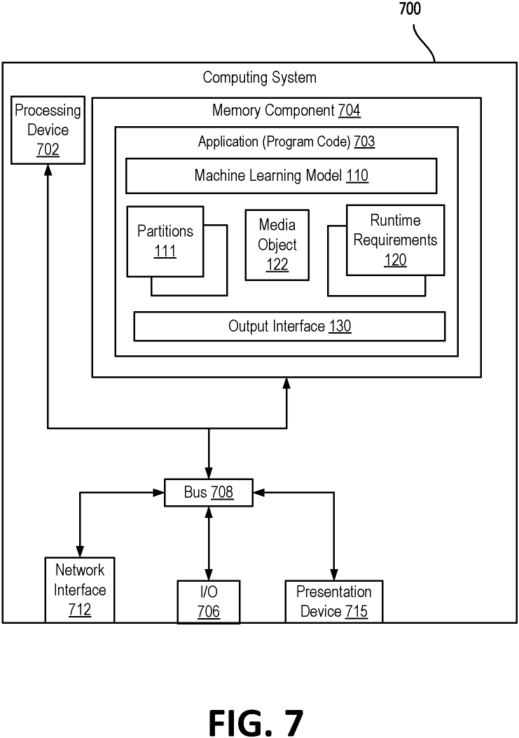

FIG. 7 depicts a computing system 700 that executes the application 102 with the capability of runtime-specific partitioning of machine learning models according to embodiments described herein. System 700 includes a processing device 702 communicatively coupled to one or more memory components 704. The processing device 702 executes computer-executable program code stored in the memory component 704. Examples of the processing device 702 include a microprocessor, an application-specific integrated circuit (“ASIC”), a field-programmable gate array (“FPGA”), or any other suitable processing device. The processing device 702 can include any number of processing devices, including a single processing device. The memory component 704 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

Still referring to FIG. 7, the computing system 700 may also include a number of external or internal devices, for example, input or output devices. For example, the computing system 700 is shown with one or more input/output (“I/O”) interfaces 706. An I/O interface 706 can receive input from input devices or provide output to output devices (not shown). One or more buses 708 are also included in the computing system 700. The bus 708 communicatively couples one or more components of a respective one of the computing system 700. The processing device 702 executes program code that configures the computing system 700 to perform one or more of the operations described herein. The program code includes, for example, application 703, which may be a software development application, a document viewing application, or other suitable application that performs one or more operations described herein. The program code may be resident in the memory component 704 or any suitable computer-readable medium and may be executed by the processing device 702 or any other suitable processor. Memory component 704, during operation of the computing system, provides executable portions of the application, for example, output interface 130 for access by the processing device 702 as needed. Memory component 704 is also used to store a machine learning model 110, partitions 111, runtime requirement definitions 120, a media object 122, and other information or data structures, shown or not shown in FIG. 7, as needed.

The system 700 of FIG. 7 also includes a network interface device 712. The network interface device 712 includes any device or group of devices suitable for establishing a wired or wireless data connection to one or more data networks. Non-limiting examples of the network interface device 712 include an Ethernet network adapter, a wireless network adapter, and/or the like. The system 700 is able to communicate with one or more other computing devices (e.g., another computing device executing software, for an application development or distribution) via a data network (not shown) using the network interface device 712. Network interface device 712 can also be used to communicate with network or cloud storage used as a repository for machine learning model partitions. Such network or cloud storage can also include updated or archived versions of the application 703 for distribution and/or installation.

Staying with FIG. 7, in some embodiments, the computing system 700 also includes the presentation device 715 depicted in FIG. 7. A presentation device 715 can include any device or group of devices suitable for providing visual, auditory, or other suitable sensory output. In examples, presentation device 715 displays media objects or portions of media objects. Non-limiting examples of the presentation device 715 include a touchscreen, a monitor, a separate mobile computing device, etc. In some aspects, the presentation device 715 can include a remote client-computing device that communicates with the computing system 700 using one or more data networks. System 700 may be implemented as a unitary computing device, for example, a notebook or mobile computer. Alternatively, as an example, the various devices included in system 700 may be distributed and interconnected by interfaces or a network, with a central or main computing device including one or more processors.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “selecting,” “creating,” and “determining,” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “configured to” herein is meant as open and inclusive language that does not foreclose devices adapted to or configured to perform additional tasks or steps. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method comprising:
accessing a machine learning model configured for processing a data object;
partitioning the machine learning model into a plurality of partitions of the machine learning model;
characterizing each of the plurality of partitions of the machine learning model with respect to runtime requirements;
executing each of the plurality of partitions of the machine learning model using a runtime environment corresponding to runtime requirements of the respective partition, to process the data object; and
rendering output based on the processing of the data object.

2. The method of claim 1, wherein the runtime requirements comprise at least one of a low-memory complex operator requirement, a high-memory optimized operator requirement, a specialized post-processing requirement, GPU-efficient runtime requirements, or CPU-efficient runtime requirements.

3. The method of claim 1, wherein at least one of the plurality of partitions is reused among a plurality of machine learning models.

4. The method of claim 1, further comprising applying a partition-specific security profile to at least one of the plurality of partitions.

5. The method of claim 4, wherein the partition-specific security profile comprises applying encryption to at least some layers of the machine learning model.

6. The method of claim 1, wherein the data object comprises a document and the processing of the data object comprises detecting portions of the document to apply a plurality of rendering resources to the document.

7. The method of claim 1, wherein the data object comprises presentation media and the processing of the data object comprises at least one of translation, captioning, or detecting portions of the data object to apply a plurality of rendering resources.

8. A system comprising:
a memory component; and
a processing device coupled to the memory component to perform operations comprising:
partitioning the machine learning model into a plurality of partitions;
characterizing each of the plurality of partitions of the machine learning model with respect to runtime requirements;
configuring each of the plurality of partitions of the machine learning model for execution using a runtime environment corresponding to the respective runtime requirements to process a data object; and
distributing the plurality of partitions to a computing device.

9. The system of claim 8, wherein the operations further comprise:
executing each of the plurality of partitions of the machine learning model using the runtime environment corresponding to the respective runtime requirements to process the data object; and
rendering output based on the processing of the data object.

10. The system of claim 8, wherein at least one of the plurality of partitions is configured for reuse among a plurality of machine learning models.

11. The system of claim 8, wherein the operations further comprise applying a partition-specific security profile to at least one of the plurality of partitions.

12. The system of claim 11, wherein the partition-specific security profile comprises encryption for at least some layers of the machine learning model.

13. The system claim 8, wherein the data object comprises a document and the processing of the data object comprises detecting portions of the document to apply a plurality of rendering resources to the document.

14. The computer-implemented method of claim 8, wherein the data object comprises presentation media and the processing of the data object comprises at least one of translation, captioning, or detecting portions of the data object to apply a plurality of rendering resources.

15. A non-transitory computer-readable medium storing executable instructions, which when executed by a processing device, cause the processing device to perform operations comprising:
a step for providing a plurality of partitions of a machine learning model configured for processing a data object, wherein each partition of the plurality of partitions is configured for execution using a runtime environment corresponding to its respective runtime requirements;
executing each of the plurality of partitions of the machine learning model on a computing device using the runtime environment; and
rendering output based on the processing of the data object.

16. The non-transitory computer-readable medium of claim 15, wherein the runtime requirements comprise at least one of a low-memory complex operator requirement, a high-memory optimized operator requirement, a specialized post-processing requirement, GPU-efficient runtime requirements, or CPU-efficient runtime requirements.

17. The non-transitory computer-readable medium of claim 15, wherein at least one of the plurality of partitions is reused among a plurality of machine learning models.

18. The non-transitory computer-readable medium of claim 15, wherein the operations further comprise applying a partition-specific security profile to at least one of the plurality of partitions.

19. The non-transitory computer-readable medium of claim 15, wherein the data object comprises a document and the processing of the data object further comprises detecting portions of the document to apply a plurality of rendering resources to the document.

20. The non-transitory computer-readable medium of claim 15, wherein the data object comprises presentation media and the processing of the data object comprises at least one of translation, captioning, or detecting portions of the data object to apply a plurality of rendering resources.
